(19) United States
(12) Patent Application Publication
(10) Pub. No.: US 2024/0306064 A1
(43) Pub. Date: Sep. 12, 2024

(54) RESOURCE CONFIGURATION METHODS AND APPARATUSES FOR HANDOVER PROCESS, DEVICE, CHIP AND STORAGE MEDIUM

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 18/667,265

(22) Filed: May 17, 2024

Related U.S. Application Data
(63) Continuation of application No. PCT/CN2021/140626, filed on Dec. 22, 2021.

(51) Int. Cl. H04W 36/08; H04B 7/06; H04W 36/00; H04W 84/06

(52) U.S. Cl. CPC H04W 36/08; H04B 7/06968; H04W 36/0064; H04W 84/06

(57) ABSTRACT

Provided is a method for configuring resources in a handover process. The method includes: receiving, by a terminal device, a first handover message from a source network device, wherein the first handover message is configured by a target network device, the first handover message comprising at least one of: a subcarrier spacing configuration, a physical downlink control channel (PDCCH) configuration, a control-resource set configuration, a search space set configuration, a configured grant configuration, a first radio network temporary identifier (RNTI), timing adjustment indication information, an uplink scheduling timing offset value Koffset, or uplink transmission waveform information, the target network device being a network device of a target cell; and accessing, by the terminal device, the target cell based on the first handover message.

### CROSS-REFERENCE TO RELATED APPLICATION

This application is a continuation of International Application No. PCT/CN2021/140626, filed Dec. 22, 2021, the entire disclosure of which is incorporated herein by reference.

### TECHNICAL FIELD

The present disclosure relates to the field of communications, and in particular, relates to a method and apparatus for configuring resources in a handover process, a device, a chip, and a storage medium.

### BACKGROUND

In a new radio (NR) system and/or a non-terrestrial network (NTN) system, a random access channel (RACH)-less handover (RACH-less HO) process may be introduced.

### SUMMARY

Embodiments of the present disclosure provide a method and apparatus for configuring resources in a handover process, a device, a chip, and a storage medium.

According to some embodiments of the present disclosure, a method for configuring resources in a handover process is provided. The method includes: receiving, by a terminal device, a first handover message from a source network device, wherein the first handover message is configured by a target network device, the target network device being a network device of a target cell; and accessing, by the terminal device, the target cell based on the first handover message.

According to some embodiments of the present disclosure, a method for configuring resources in a handover process is provided. The method includes: configuring, by a target network device, a first handover message; and transmitting, by the target network device, the first handover message to a terminal device over a source network device; wherein the first handover message is configured for the terminal device to access a target cell, and the target network device is a network device of the target cell.

According to some embodiments of the present disclosure, a method for configuring resources in a handover process is provided. The method includes: receiving, by a source network device, a first handover message configured by a target network device; and transmitting, by the source network device, the first handover message to a terminal device; wherein the first handover message is configured for the terminal device to access a target cell, and the target network device is a network device of the target cell.

According to some embodiments of the present disclosure, an apparatus for configuring resources in a handover process is provided. The apparatus includes: a receiver module, configured to receive a first handover message from a source network device, wherein the first handover message is configured by a target network device, the target network device being a network device of a target cell; and an access module, configured to access the target cell based on the first handover message.

According to some embodiments the present disclosure, an apparatus for configuring resources in a handover process is provided. The apparatus includes: a configuration module, configured to configure a first handover message; and a transmitter module, configured to transmit the first handover message to a terminal device over a source network device; wherein the first handover message is configured for the terminal device to access a target cell, a target network device being configured in the target cell.

According to some embodiments of the present disclosure, an apparatus for configuring resources in a handover process is provided. The apparatus includes: a receiver module, configured to receive a first handover message configured by a target network device; and a transmitter module, configured to transmit the first handover message to a terminal device; wherein the first handover message is configured for the terminal device to access a target cell, and the target network device is a network device of the target cell.

According to some embodiments of the present disclosure, a communication device is provided. The communication device includes: a processor and a memory, wherein the memory is configured to store a computer program, and the processor, when loading and running the computer program, is caused to perform the method for configuring resources in a handover process as described above.

According to some embodiments of the present disclosure, a chip is provided. The chip includes a programmable logic circuit and/or a program instruction. The chip, when running, is caused to perform the method for configuring resources in a handover process as described above.

According to some embodiments of the present disclosure, a non-transitory computer-readable storage medium storing a computer program is provided. The non-transitory computer program, when loaded and run on a processor, causes the processor to perform the method for configuring resources in a handover process as described above.

It is understandable that both the above general description and the following detailed description are exemplary and explanatory only and are not construed as limiting the present disclosure.

### BRIEF DESCRIPTION OF THE DRAWINGS

For clearer illustration of the technical solutions in embodiments of the present disclosure, accompanying drawings required for describing the embodiments are briefly introduced hereinafter. It is apparent that the accompanying drawings described hereinafter merely illustrate some embodiments of the present disclosure, and those of ordinary skill in the art may derive other drawings from these accompanying drawings without creative efforts.

FIG. 1 is a schematic diagram of an architecture of a communication system according to some embodiments of the present disclosure;

FIG. 2 is a flowchart of a method for configuring resources in a handover process according to some embodiments of the present disclosure;

FIG. 3 is a flowchart of a method for configuring resources in a handover process according to some embodiments of the present disclosure;

FIG. 4 is a flowchart of a method for configuring resources in a handover process according to some embodiments of the present disclosure;

FIG. 5 is a flowchart of a method for configuring resources in a handover process according to some embodiments of the present disclosure;

FIG. 6 is a flowchart of a method for configuring resources in a handover process according to some embodiments of the present disclosure;

FIG. 7 is a flowchart of a method for configuring resources in a handover process according to some embodiments of the present disclosure;

FIG. 8 is a flowchart of a method for configuring resources in a handover process according to some embodiments of the present disclosure;

FIG. 9 is a flowchart of a method for configuring resources in a handover process according to some embodiments of the present disclosure;

FIG. 10 is a flowchart of a method for configuring resources in a handover process according to some embodiments of the present disclosure;

FIG. 11 is a structural block diagram of an apparatus for configuring resources in a handover process according to some embodiments of the present disclosure;

FIG. 12 is a structural block diagram of an apparatus for configuring resources in a handover process according to some embodiments of the present disclosure;

FIG. 13 is a structural block diagram of an apparatus for configuring resources in a handover process according to some embodiments of the present disclosure; and

FIG. 14 is a structural block diagram of a communication device according to some embodiments of the present disclosure.

### DETAILED DESCRIPTION

Reference is made in detail to the exemplary embodiments, examples of which are illustrated in the accompanying drawings. Where the description hereinafter relates to the accompanying drawings, unless otherwise specified, identical reference numerals in the accompanying drawings denote identical or like elements. The embodiments described in the following exemplary embodiments do not represent all embodiments consistent with the present disclosure. Rather, they are merely examples of apparatus and methods consistent with certain aspects of the present disclosure, as detailed in the appended claims.

Currently, 3GPP is researching non-terrestrial network (NTN) technology, and the NTN generally provides communication services for ground users by means of satellite communications. The NTN system currently includes a new radio NTN (NR-NTN) system and an Internet of things NTN (IoT-NTN) system.

In some embodiments, FIG. 1A is a schematic diagram of an architecture of a communication system according to some embodiments of the present disclosure. As shown in FIG. 1A, a communication system includes a network device 1201, wherein the network device 1201 is a device communicating with a terminal device 1101 (or referred to as a communication terminal, or a terminal). The network device 1201 provides communication coverage for a particular geographic region and communicates with terminal devices located within a coverage region.

FIG. 1A exemplarily shows one network device and two terminal devices. In some embodiments of the present disclosure, the communication system includes a plurality of network devices and the coverage region of each of the network devices includes another number of terminal devices, which are not limited in the embodiments of the present disclosure.

FIG. 1B shows a schematic diagram of an architecture of another communication system according to some embodiments of the present disclosure. Referring to FIG. 1B, a communication system includes a terminal device 1102 and a satellite 1301, wherein wireless communications are carried out between the terminal device 1102 and the satellite 1301. A network formed between the terminal device 1102 and the satellite 1301 may also be referred to as an NTN. In the architecture of the communication system shown in FIG. 1B, the satellite 1301 functions as a base station, and communications are performed directly between the terminal device 1102 and the satellite 1301. In the system architecture, the satellite 1301 may be referred to as a network device. In some embodiments of the present disclosure, the communication system includes a plurality of network devices 1301, and the coverage region of each of the network devices 1301 includes other number of terminal devices, which are not limited in the embodiments of the present disclosure.

In some embodiments, FIG. 1C is a schematic diagram of an architecture of another communication system according to some embodiments of the present disclosure. Referring to FIG. 1C, a communication system includes a terminal device 1103, a satellite 1302, and a base station 1202, wherein wireless communications are carried out between the terminal device 1103 and the satellite 1302, and communications are carried out between the satellite 1302 and the base station 1202. A network formed between the terminal device 1103, the satellite 1302, and the base station 1202 may also be referred to as an NTN. In the architecture of the communication system shown in FIG. 1C, the satellite 1302 does not function as a base station, and communications between the terminal device 1103 and the base station 1202 need to be relayed over the satellite 1302. In the system architecture, the base station 1202 may be referred to as a network device. In some embodiments of the present disclosure, the communication system includes a plurality of network devices 1202, and the coverage region of each of the network devices 1202 includes other number of terminal devices, which are not limited in the embodiments of the present disclosure.

The embodiments of the present disclosure are described in conjunction with a network device and a terminal device, wherein the terminal device may also be referred to as a user equipment (UE), an access terminal, a subscriber unit, a subscriber station, a rover station, a mobile station (MS), a mobile terminal (MT), a remote station, a remote terminal, a mobile device, a user terminal, a terminal, a wireless communication device, a user agent, or a user device.

In the embodiments of the present disclosure, the terminal device is a station (ST) in a wireless local area network (WLAN), or a cellular phone, a cordless phone, a session initiation protocol (SIP) phone, a wireless local loop (WLL) station, a personal digital assistant (PDA) device, a handheld device with wireless communication function, a computing device, or other processing device connected to a wireless modem, a vehicle-mounted device, a wearable device, a terminal device in a next generation communication system such as an NR network, or a terminal device in a public land mobile network (PLMN) evolved in the future, or the like.

In the embodiments of the present disclosure, the terminal device is a device providing voice and/or data connectivity for a user, and is configured to connect people, things, and machines, such as a handheld device with wireless connection function or a vehicle-mounted device. The terminal device in the embodiments of the present disclosure is a mobile phone, a tablet computer (Pad), a laptop computer, a pocket PC, a mobile Internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. In some embodiments, the UE is configured to act as a base station. For example, the UE acts as a scheduling entity providing sidelink signals between UEs in V2X or D2D, or the like. For example, cellular phones and automobiles communicate with each other over sidelink signals. Cellular phones and smart home devices communicate with each other without relaying communication signals via a base station.

In the embodiments of the present disclosure, the terminal device is deployed on land, including indoor or outdoor, handheld, wearable or vehicle-mounted; or deployed on the water surface (such as ships); or deployed in the air (such as airplanes, balloons, or satellites).

In the embodiments of the present disclosure, the terminal device is a mobile phone, a tablet computer (pad), a computer with a wireless transceiving function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home. The terminal device according to the embodiments of the present disclosure may also be referred to as a terminal, a user equipment (UE), an access terminal device, a vehicle-mounted terminal, an industrial control terminal, a UE unit, a UE station, a rover station, a mobile station, a remote station, a remote terminal device, a mobile device, a UE terminal device, a wireless communication device, a UE agent, or a UE device. The terminal device is fixed or mobile.

By way of example and not limitation, in the embodiments of the present disclosure, the terminal device may be a wearable device. The wearable device, also known as a wearable smart device, is the general name of wearable devices, such as glasses, gloves, watches, clothing and shoes, which are intelligently designed and developed for daily wear by using wearable technologies. The wearable device is a portable device that is worn directly on the body or integrated into the user's clothing or accessory. The wearable device is not only a hardware device, but also implements powerful functions based on software support, data interaction and cloud interaction. Generally, wearable smart devices include devices such as smart watches or smart glasses that have full functions and large size, and implement complete or partial functions without depending on smart phones, and devices, such as all kinds of smart bracelets and smart jewelry for physical sign monitoring, that only focus on a certain type of application function, and need to be matched with other devices such as smart phones for use.

The network device in the embodiments of the present disclosure is a device configured to communicate with a terminal device, and the network device may also be referred to as an access network device or a radio access network device. For example, the network device is a base station. The network device in the embodiments of the present disclosure may refer to a radio access network (RAN) node (or device) that accesses a terminal device to a wireless network. The base station broadly covers or replaces various names such as: NodeB, evolved NodeB (CNB), next generation NodeB (gNB), relay station, transmitting and receiving point (TRP), transmitting point (TP), master base station (MeNB), secondary base station (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node, and the like. The base station is a macro base station, a micro base station, a relay node, a donor node, or the like, or a combination thereof. The base station may also refer to a communication module, modem or chip that is configured to be arranged in the aforementioned devices or apparatuses. The base station is also a mobile switching center, a device that implements the functions of a base station in device-to-device (D2D), vehicle-to-everything (V2X) and machine-to-machine (M2M) communications, a network-side device in a 6G network, a device that implements the functions of a base station in a future communication system, or the like. The base stations support networks of the same or different access technologies. Specific technologies and specific device forms used by the network devices are not limited in the embodiments of the present disclosure.

The base station is fixed or mobile. For example, a helicopter or drone is configured to act as a mobile base station, and one or more cells move based on a position of the mobile base station. In other examples, a helicopter or drone is configured to serve as a device to communicate with another base station.

In some deployments, the network devices in the embodiments of the present disclosure refer to CUs or DUs, or the network devices include the CU and the DU. The gNB further includes an AAU.

The network device and the terminal device are deployed on land, including indoors or outdoors, handheld or vehicle-mounted; or deployed on the water surface; or deployed on aerial airplanes, balloons, and satellites. Scenarios of the network device and the terminal device are not limited in the embodiments of the present disclosure.

By way of example and not limitation, in the embodiments of the present disclosure, the network device has a mobile nature. For example, the network device is a mobile device. In some embodiments of the present disclosure, the network device is a satellite or balloon station. For example, the satellite is a low earth orbit (LEO) satellite, a medium earth orbit (MEO) satellite, a geostationary earth orbit (GEO) satellite, a high elliptical orbit (HEO) satellite, or the like. In some embodiments of the present disclosure, the network device may be a base station located on land, in water, or the like.

In the embodiments of the present disclosure, a network device provides a service for a cell, and a terminal device communicates with the network device based on a transmission resource (e.g., a frequency domain resource or a frequency spectrum resource) used by the cell, wherein the cell is a cell corresponding to the network device (e.g., a base station), and the cell belongs to a macro base station or a base station corresponding to a small cell, wherein the small cell may include: a metro cell, a micro cell, a pico cell, a femto cell, and the like, and the small cells have the characteristics of small coverage region and low transmission power, and are suitable for providing high-rate data transmission services.

It is understandable that the “indication” mentioned in the embodiments of the present disclosure is a direct indication, an indirect indication, or an indication that there is an association. For example, A indicates B, which can mean that A indicates B directly, e.g., B may be acquired by A; or that A indicates B indirectly, e.g., A indicates C, wherein B may be acquired by C; or that an association is present between A and B.

In a related art of the present disclosure, a long term evolution (LTE) system supports a RACH-less based handover. In the case that a terminal device in a connected state is configured with the RACH-less based handover, the handover process is as follows.

Firstly, a source base station of a source cell initiates a HANDOVER REQUEST message to a target base station of a target cell; and

in some embodiments, the HANDOVER REQUEST message includes a target cell ID and/or a cell-radio network temporary identifier (also referred to as an old C-RNTI) of a terminal device to be handed over in the source cell.

Secondly, the target base station transmits a HANDOVER REQUEST ACKNOWLEDGE message to the source base station.

In some embodiments, the HANDOVER REQUEST ACKNOWLEDGE message includes a radio resource control (RRC) message, such as a transparent container, transmitted to the terminal device for implementing handover. In some embodiments, the RRC message (or the transparent container) includes a new C-RNTI (C-RNTI allocated by the target base station) and timing adjustment indication information. In some embodiments, the RRC message further includes pre-allocated uplink grant (PUG) information.

Thirdly, the source base station forwards the RRC message transmitted by the target base station to the terminal device.

Finally, the terminal device receives the RRC message, and initiates a handover process based on the timing adjustment indication information upon completing a synchronization with the target cell.

In some embodiments, the RRC message includes pre-allocated uplink grant information, and the terminal device accesses the target cell based on the pre-allocated uplink grant information; and in some embodiments, the pre-allocated uplink grant information includes the following information:

The number of pre-configured uplink HARQ processes (NumberOfConfUL-Processes): takes a value of 1 to 8.

Uplink scheduling interval (ul-SchedInterval): takes a value of 2 subframes, 5 subframes or 10 subframes.

Uplink start subframe (ul-StartSubframe): takes a value of 0 to 9.

Uplink grant information (ul-Grant): includes 16 bits. In some embodiments, the uplink grant information includes: frequency hopping indication, 1 bit; fixed-size resource block (RB) allocation, 10 bits; and a truncated modulation and coding scheme (MCS), 4 bits; and a CQI request, 1 bit.

In some embodiments, the RRC message does not include pre-allocated uplink grant information, and the terminal device receives the uplink grant information by monitoring the PDCCH of the target cell.

In some embodiments, upon synchronization with the target cell, the terminal device accesses the target cell based on the first available uplink grant information.

In some embodiments, in the case that the terminal device determines the N_{TA} parameter in the synchronization process, one of the following three cases is included: timing adjustment indication information is used, N_{TA}-0, or N_{TA} of the source cell is reused. The N_{TA} value is configured to determine a TA value of the terminal device when accessing the target cell.

In some embodiments, the timing adjustment indication information indicates that the target timing advance (target TA) is one of: ta0, master cell group-primary timing advance group (mcg-PTAG), secondary cell group-primary timing advance group (scg-PTAG), master cell group-secondary timing advance group (mcg-STAG), and secondary cell group-secondary timing advance group (scg-STAG). The ta0 corresponds to N_{TA}=0; the meg-PTAG corresponds to the latest N_{TA} value in a PTAG of a reuse-associated MCG; the seg-PTAG corresponds to the latest N_{TA} value in the PTAG of a reuse-associated SCG; the meg-STAG corresponds to the latest N_{TA} value of MCG STAG indicated by STAG-Id; and the seg-STAG corresponds to the latest N_{TA} value of SCG STAG indicated by STAG-Id.

In some optional embodiments, during the handover process, the source base station and the terminal device both retain some context (e.g., C-RNTI), such that the terminal device can return to the source base station in response to a handover failure.

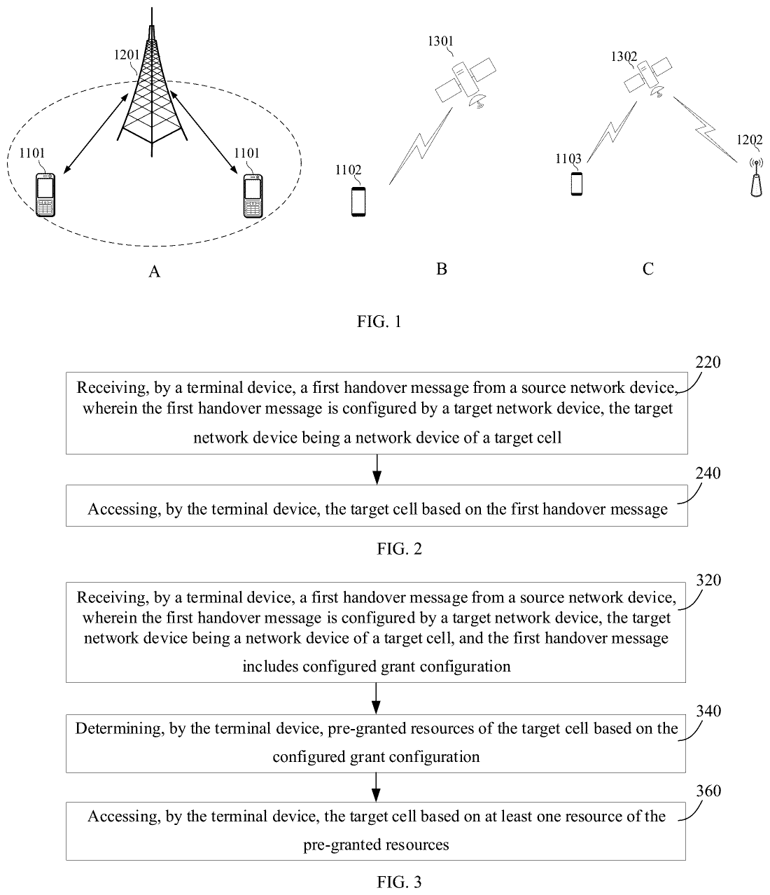

FIG. 2 is a flowchart of a method for configuring resources in a handover process according to some embodiments of the present disclosure. The method includes the following processes.

In process 220, a terminal device receives a first handover message from a source network device, wherein the first handover message is configured by a target network device, the target network device being a network device of a target cell.

In some optional embodiments, the first handover message carries configuration information associated with an NR system; and/or the source network device is a network device in the NR system; and/or the target network device is a network device in the NR system.

In some optional embodiments, the first handover message carries configuration information associated with an NTN system; and/or the source network device is a network device in the NTN system; and/or the target network device is a network device in the NTN system.

In some optional embodiments, the first handover message includes timing adjustment indication information and/or an uplink scheduling timing offset value Koffset.

In some optional embodiments, the first handover message includes at least one of: a subcarrier spacing configuration; a physical downlink control channel (PDCCH) configuration; a control-resource set configuration; a search space set configuration; a configured grant configuration; a first RNTI; a timing adjustment indication information; an uplink scheduling timing offset value Koffset; or uplink transmission waveform information.

In all the embodiments of the present disclosure, for the subcarrier spacing configuration, optionally, the subcarrier spacing configuration is configured to determine a first subcarrier spacing, wherein the first subcarrier spacing is configured for the terminal device to transmit the physical uplink shared channel (PUSCH) and/or the physical uplink control channel (PUCCH) to the target cell. For example, the subcarrier spacing configuration indicates the first subcarrier spacing. In some embodiments, the subcarrier spacing configuration is configured to determine a second subcarrier spacing, wherein the second subcarrier spacing is configured for the terminal device to receive the PDCCH and/or the physical downlink shared channel (PDSCH) from the target cell. For example, the subcarrier spacing configuration indicates the second subcarrier spacing. In some embodiments, the first subcarrier spacing is the same as the second subcarrier spacing. For example, a subcarrier spacing indicated by the subcarrier spacing configuration is both the first subcarrier spacing and the second subcarrier spacing.

In all the embodiments of the present disclosure, for the PDCCH configuration, optionally, the PDCCH configuration is configured to determine control-resource set configuration and/or search space set configuration associated with a PDCCH candidate of the target cell. In some embodiments, the PDCCH configuration indicates a control-resource set ID and/or a search space set ID associated with the PDCCH candidate in the case that the terminal device monitors the PDCCH candidate of the target cell.

In all the embodiments of the present disclosure, with respect to the control-resource set configuration, optionally, the control-resource set configuration indicates control-resource set configuration information associated with the control-resource set ID and/or the search space set ID. In some embodiments, the control-resource set configuration information is configured to determine at least one of: RBs occupied by a control-resource set in a frequency domain, the number of symbols occupied by the control-resource set in a time domain, or quasi co-location information associated with the control-resource set.

In all the embodiments of the present disclosure, optionally, the case that the control-resource set configuration information is configured to determine the RBs occupied by the control-resource set in the frequency domain includes that: the control-resource set configuration information indicates at least one of: a starting RB of the control-resource set in the frequency domain, the number of RBs occupied by the control-resource set in the frequency domain, or the RBs occupied by the control-resource set in the frequency domain.

In all the embodiments of the present disclosure, optionally, the case that the control-resource set configuration information is configured to determine the number of symbols occupied by the control-resource set in the time domain includes that: the control-resource set configuration information indicates the number of symbols occupied by the control-resource set in the time domain.

In all the embodiments of the present disclosure, optionally, the case that the control-resource set configuration information is configured to determine the quasi co-location information associated with the control-resource set includes that: the control-resource set configuration information indicates quasi co-location information associated with the control-resource set.

It is understandable that quasi co-location (QCL) means that large-scale parameters of a channel experienced by symbols on one antenna port can be inferred from a channel experienced by symbols on another antenna port. For example, the large-scale parameters include delay spread, average delay, Doppler spread, Doppler shift, average gain, spatial reception parameters, and the like.

In all the embodiments of the present disclosure, optionally, the quasi co-location information includes at least one of: transmission configuration indicator (TCI) information, QCL reference signal information, or QCL type configuration.

In all the embodiments of the present disclosure, optionally, the QCL type configuration includes at least one of: “QCL-TypeA,” “QCL-TypeB,” “QCL-TypeC,” or “QCL-TypeD.”

In all the embodiments of the present disclosure, optionally, the different QCL type configurations are defined as follows.
“QCL-TypeA”: {Doppler shift, Doppler spread, average delay, and delay spread};
“QCL-TypeB”: {Doppler shift and Doppler spread};
“QCL-TypeC”: {Doppler shift and average delay}; and
“QCL-TypeD”: {spatial Rx parameter}.

In all the embodiments of the present disclosure, for the search space set configuration, optionally, the search space set configuration indicates search space set configuration information associated with the search space set ID. In some embodiments, the search space set configuration information is configured to determine at least one of: time units occupied by a search space set in a time domain, symbols occupied by the search space set in the occupied time units, a search space set type, a downlink control information (DCI) format of the PDCCH candidate, an aggregation level associated with the PDCCH candidate, or blind monitoring times corresponding to the aggregation level of the PDCCH candidate.

In all the embodiments of the present disclosure, optionally, the case that the search space set configuration information is configured to determine the time units occupied by the search space set in the time domain includes that: the search space set configuration information indicates a monitoring slot cycle and/or an offset configuration parameter of the search space set. In some embodiments, the time units occupied by the search space set in the time domain include timeslots determined based on the monitoring slot cycle and the offset configuration parameter.

In all the embodiments of the present disclosure, optionally, the case that the search space set configuration information is configured to determine the symbols occupied by the search space set in the occupied time units includes that: the search space set configuration information indicates the symbols occupied by timeslots determined based on the monitoring slot cycle and/or the offset configuration parameter of the search space set. In some embodiments, the search space set configuration information is configured to take the symbols occupied by the timeslots determined based on the monitoring slot cycle and the offset configuration parameter as starting symbols of the search space set.

In all the embodiments of the present disclosure, optionally, the case that the search space set configuration information is configured to determine the search space set type includes that: the search space set configuration information indicates a common search space set and/or a UE-specific search space set.

In all the embodiments of the present disclosure, optionally, the DCI format includes at least one of: DCI format 0_0 or DCI format 1_0.

In all the embodiments of the present disclosure, with respect to the configured grant configuration, optionally, the configured grant configuration is configured to determine at least one of: a configured grant configuration ID, frequency domain frequency hopping indication, demodulation reference signal (DMRS) parameter configuration, a frequency domain resource allocation type, uplink transmission waveform information, the number of pre-configured uplink hybrid automatic repeat request (HARQ) processes, periods of pre-granted resources, the number of repetitions of transmissions over the pre-granted resources, a corresponding redundancy version (RV) of repeated transmissions over the pre-granted resources, time units occupied by the pre-granted resources in a time domain, starting symbols and the number of symbols occupied by the pre-granted resources in occupied time units, resource blocks (RBs) occupied by the pre-granted resources in a frequency domain, an antenna port, a DMRS sequence initialization parameter, precoding and layer number indication, modulation and coding scheme (MCS) and transport block size (TBS) indication, sounding reference signal (SRS) resource indication, frequency domain frequency hopping offset indication, or path loss reference indication.

In all the embodiments of the present disclosure, optionally, the case that the configured grant configuration is configured to determine the frequency domain frequency hopping indication includes that: the configured grant configuration indicates whether the frequency hops, and/or frequency hopping within a time unit, and/or frequency hopping between time units.

In all the embodiments of the present disclosure, optionally, the case that the configured grant configuration is configured to determine the DMRS parameter configuration includes that: the configured grant configuration indicates a position of the DMRS in the pre-granted resources.

In all the embodiments of the present disclosure, optionally, the case that the configured grant configuration is configured to determine the frequency domain resource allocation type includes that: the configured grant configuration indicates a type on which the frequency domain resource allocation is based. In some embodiments, the configured grant configuration indicates that the frequency domain resource allocation is performed based on type 0 or type 1 or type 2.

In all the embodiments of the present disclosure, optionally, the case that the configured grant configuration is configured to determine the time units occupied by the pre-granted resources in the time domain includes that: the configured grant configuration indicates that timeslots occupied by the pre-granted resource in the time domain are determined based on a time domain offset.

In all the embodiments of the present disclosure, optionally, the case that the configured grant configuration is configured to determine the starting symbols and the number of symbols occupied by the pre-granted resources in the occupied time units includes that: the configured grant configuration indicates that the starting symbols and the number of symbols occupied by the pre-granted resources in the occupied timeslots are determined based on time domain resource allocation information.

In all the embodiments of the present disclosure, optionally, the case that the configured grant configuration is configured to determine the RBs occupied by the pre-granted resources in the frequency domain includes that: the configured grant configuration indicates that the RBs occupied by the pre-granted resources in the frequency domain are determined based on a frequency domain resource allocation parameter and a frequency domain resource allocation type.

In all the embodiments of the present disclosure, with respect to the first RNTI, optionally, the first RNTI includes a cell-radio network temporary identifier (C-RNTI) allocated by the target network device to the terminal device. In some embodiments, the first RNTI includes a configured scheduling-radio network temporary identifier (CS-RNTI) allocated by the target network device to the terminal device.

In all the embodiments of the present disclosure, with respect to the timing adjustment indication information, optionally, the timing adjustment indication information is configured to determine a TA value of the target cell. For example, the timing adjustment indication information is configured to determine a TA value used by the terminal device when performing PUSCH transmission based on PUSCH resources in the target cell.

In all the embodiments of the present disclosure, optionally, an association relationship is present between the TA value of the target cell, the timing adjustment indication information, and the first subcarrier spacing. For example, the TA value of the target cell is determined based on the timing adjustment indication information and the first subcarrier spacing. The first subcarrier spacing is configured for the terminal device to transmit the PUSCH and/or the PUCCH to the target cell.

In all the embodiments of the present disclosure, optionally, in the case that the terminal device determines the N_{TA} parameter in the process of determining the TA value of the target cell, one of the following three cases is included: timing adjustment indication information is used, N_{TA}=0, or N_{TA} of the source cell is reused. In some embodiments, the timing adjustment indication information indicates the TA value of the target cell, and the timing adjustment indication information is determined based on one of: ta0, meg-PTAG, scg-PTAG, mcg-STAG, or scg-STAG.

In all the embodiments of the present disclosure, optionally, the timing adjustment indication information is configured to determine at least one of: ephemeris information, a common TA value, a common drift value, a common drift variation rate, common transmission delay, a reference moment t0 (epoch time), or a timer length. In some embodiments, in this case, the configuration of the timing adjustment indication information is applied in the NTN network.

In all the embodiments of the present disclosure, optionally, the timer length is configured to determine a validity period of at least one piece of information in the timing adjustment indication information. In some embodiments, the terminal device completes time domain synchronization and/or frequency domain synchronization with the first network device based on information acquired by the timing adjustment indication information and the global navigation satellite system (GNSS) capability of the terminal device.

In all the embodiments of the present disclosure, with respect to the uplink scheduling timing offset value Koffset, optionally, the uplink scheduling timing offset value Koffset is configured to determine at least one of the following scheduling timings: timing of PUSCH transmission from the terminal device to the first network device, or timing of PUCCH transmission from the terminal device to the first network device. In some embodiments, in this case, the uplink scheduling timing offset value Koffset is applied in the NTN network.

In all the embodiments of the present disclosure, with respect to the uplink transmission waveform information, optionally, the uplink transmission waveform information is configured to determine whether a discrete Fourier transform (DFT) precoder is used in the case that the terminal device performs uplink transmission to the target network device, or is configured to determine whether a waveform used in the case that the terminal device performs uplink transmission to the target network device is an orthogonal frequency division multiplexing (OFDM) waveform or a discrete Fourier transform-spread OFDM (DFT-S-OFDM) waveform. The DFT-S-OFDM waveform may also be referred to as a single carrier waveform.

As an example, the uplink transmission waveform information is a higher-layer configuration parameter such as transformPrecoder, and in the case that the transformPrecoder is configured to be enabled, the uplink transmission waveform information indicates that the DFT precoder is used during uplink transmission (or corresponding to DFT-S-OFDM waveform); and in the case that the transformPrecoder is configured to be disabled, the uplink transmission waveform information indicates that the DFT precoder is not used during uplink transmission (or corresponding to OFDM waveform).

In some embodiments, in the case that the uplink transmission waveform information is not configured for the terminal device, a default uplink transmission waveform is that the DFT precoder is used during uplink transmission (or corresponding to the DFT-S-OFDM waveform).

In some embodiments, in the case that the uplink transmission waveform information is not configured for the terminal device, the default uplink transmission waveform is that the DFT precoder is not used during uplink transmission (or corresponding to the OFDM waveform).

In process 240, the terminal device accesses the target cell based on the first handover message.

In some optional embodiments, the first handover message carries resource configuration associated with the NR and/or the NTN, and the target cell is accessed based on access resource corresponding to the resource configuration.

In some optional embodiments, the first handover message includes the configured grant configuration. The terminal device accesses the target cell based on the configured grant configuration; and reference is made in detail to the exemplary embodiments illustrated in FIG. 3 hereinafter.

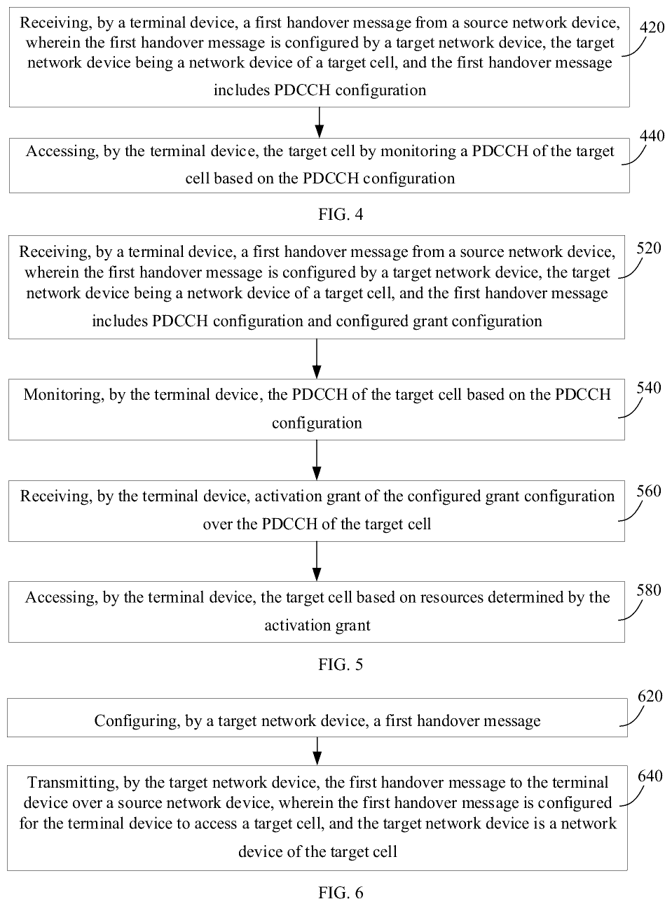

In some optional embodiments, the first handover message includes the PDCCH configuration. The terminal device accesses the target cell based on the PDCCH configuration; and reference is made in detail to the exemplary embodiments illustrated in FIG. 4 hereinafter.

In some optional embodiments, the first handover message includes the PDCCH configuration and the configured grant configuration. The terminal device accesses the target cell based on the configured grant configuration and the PDCCH configuration; and reference is made in detail to the exemplary embodiments illustrated in FIG. 5 hereinafter.

In some optional embodiments, in the NTN scenario, for example, in the case that the first handover message carries configuration information associated with an NTN system; and/or the source network device is the network device in the NTN system; and/or the target network device is the network device in the NTN system, the case that the terminal device accesses the target cell based on the first handover message includes that: upon synchronization with the target cell, the terminal device accesses the target cell based on the first handover message.

In some embodiments, in the NTN scenario, the case that the terminal device synchronizes to the target cell includes that: the terminal device synchronizes to the target cell based on the first handover message, wherein the first handover message includes the timing adjustment indication information, the timing adjustment indication information being configured to determine at least one of: ephemeris information, a common TA value, a common drift value, a common drift variation rate, common transmission delay, a reference moment t0, or a timer length.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, such that the problem of resource configuration in the RACH-less handover process is solved.

FIG. 3 is a flowchart of a method for configuring resources in a handover process according to some embodiments of the present disclosure. The method includes the following processes.

In process 320, a terminal device receives a first handover message from a source network device, wherein the first handover message is configured by a target network device, the target network device being a network device of a target cell, and the first handover message includes configured grant configuration.

In some optional embodiments, the first handover message includes: a configured grant configuration; a subcarrier spacing configuration; and a first RNTI.

With respect to the configured grant configuration, in some embodiments, the configured grant configuration is configured to determine at least one of: a configured grant configuration ID, frequency domain frequency hopping indication, DMRS parameter configuration, a frequency domain resource allocation type, uplink transmission waveform information, the number of pre-configured uplink HARQ processes, periods of pre-granted resources, the number of repetitions of transmissions over the pre-granted resources, a corresponding RV of repeated transmissions over the pre-granted resources, time units occupied by the pre-granted resources in a time domain, starting symbols and the number of symbols occupied by the pre-granted resources in occupied time units, RBs occupied by the pre-granted resources in a frequency domain, an antenna port, a DMRS sequence initialization parameter, precoding and layer number indication, MCS and TBS indication, SRS resource indication, frequency domain frequency hopping offset indication, or path loss reference indication.

In some embodiments, for the detailed description of the configured grant configuration, reference is made to the “for the configured grant configuration” in process 220.

In some embodiments, for the detailed description of the uplink transmission waveform information, reference is made to the “for the uplink transmission waveform information” in process 220.

With respect to the subcarrier spacing configuration, in some embodiments, the PUCCH to the target cell. For example, the subcarrier spacing configuration indicates the first subcarrier spacing.

For the first RNTI, in some embodiments, the first RNTI includes a C-RNTI allocated by the target network device to the terminal device.

In process 340, the terminal device determines pre-granted resources of the target cell based on the configured grant configuration.

In some optional embodiments, the terminal device determines the pre-granted resources of the target cell based on the configured grant configuration.

In process 360, the terminal device accesses the target cell based on at least one resource of the pre-granted resources.

In some embodiments, the case that the terminal device accesses the target cell based on at least one resource of the pre-granted resources includes that: the terminal device transmits the PUSCH to the target cell based on the at least one resource of the pre-granted resources.

In some optional embodiments, upon synchronization with the target cell, the terminal device transmits the PUSCH to the target cell over a first available resource of the pre-granted resources.

In some embodiments, upon synchronization with the target cell, the terminal device determines the first subcarrier spacing based on the subcarrier spacing configuration.

In some embodiments, the terminal device determines the first RNTI as a C-RNTI (also referred to as a new C-RNTI) allocated by the target network device to the terminal device.

In some embodiments, the PUSCH transmitted by the terminal device to the target cell carries the first RNTI information. As another example, the first RNTI is included in a transport block carried by the PUSCH transmitted by the terminal device. As another example, the terminal device scrambles the PUSCH based on the first RNTI.

In some embodiments, a waveform of the PUSCH is determined based on the uplink transmission waveform information; and in some embodiments, the waveform of the PUSCH is predefined.

In some optional embodiments, the source network device is a network device of a source cell, and both the source network device and the terminal device retain context information, wherein the context information is configured for the terminal device to return to the source cell in response to a handover failure.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, wherein the first handover message includes the configured grant configuration, such that the problem of resource configuration in the RACH-less handover process is solved.

FIG. 4 is a flowchart of a method for configuring resources in a handover process according to some embodiments of the present disclosure. The method includes the following processes.

In process 420, a terminal device receives a first handover message from a source network device, wherein the first handover message is configured by a target network device, the target network device being a network device of a target cell, and the first handover message includes PDCCH configuration.

In some optional embodiments, the first handover message includes: a PDCCH configuration; a control-resource set configuration; and a search space set configuration.

In some optional embodiments, the first handover message includes: a PDCCH configuration; a subcarrier spacing configuration; a control-resource set configuration; a search space set configuration; and a first RNTI.

With respect to the PDCCH configuration, in some embodiments, the PDCCH configuration is configured to determine control-resource set configuration and/or search space set configuration associated with a PDCCH candidate of the target cell; and in some embodiments, the PDCCH configuration indicates a control-resource set ID and/or a search space set ID associated with the PDCCH candidate in the case that the terminal device monitors the PDCCH candidate of the target cell.

With respect to the subcarrier spacing configuration, in some embodiments, the PUCCH to the target cell. For example, the subcarrier spacing configuration indicates the first subcarrier spacing. In some embodiments, the subcarrier spacing configuration is configured to determine a second subcarrier spacing, wherein the second subcarrier spacing is configured for the terminal device to receive the PDCCH and/or the PDSCH from the target cell. For example, the subcarrier spacing configuration indicates the second subcarrier spacing.

With respect to the control-resource set configuration, in some embodiments, the control-resource set configuration indicates control-resource set configuration information associated with the control-resource set ID and/or the search space set ID. In some embodiments, the control-resource set configuration information is configured to determine at least one of: RBs occupied by a control-resource set in a frequency domain, the number of symbols occupied by the control-resource set in a time domain, or quasi co-location information associated with the control-resource set.

In some embodiments, for the detailed description of the control-resource set configuration, reference is made to the “for the control-resource set configuration” in process 220.

With respect to the search space set configuration, in some embodiments, the search space set configuration indicates search space set configuration information associated with the search space set ID. In some embodiments, the search space set configuration information is configured to determine at least one of: time units occupied by a search space set in a time domain, symbols occupied by the search space set in occupied time units, a search space set type, a DCI format of a PDCCH candidate, an aggregation level associated with the PDCCH candidate, or blind monitoring times corresponding to the aggregation level of the PDCCH candidate.

In some embodiments, for the detailed description of the search space set configuration, reference is made to the “for the search space set configuration” in process 220.

With respect to the first RNTI, in some embodiments, the first RNTI includes a C-RNTI allocated by the target network device to the terminal device.

In process 440, the terminal device accesses the target cell by monitoring the PDCCH of the target cell based on the PDCCH configuration.

In some optional embodiments, the terminal device monitors a PDCCH candidate based on the first RNTI on a search space set determined based on the PDCCH configuration.

In some embodiments, the terminal device determines a control-resource set ID and/or a search space set ID associated with the PDCCH candidate based on the PDCCH configuration.

In some embodiments, the terminal device determines the control-resource set based on the control-resource set and at least one of the control-resource set ID or the search space set ID.

In some embodiments, the terminal device determines the search space set based on the search space set configuration and the search space set ID.

In some embodiments, the terminal device determines the second subcarrier spacing based on the subcarrier spacing configuration.

In some embodiments, the terminal device determines the first RNTI as the C-RNTI (also referred to as a new C-RNTI) allocated by the target network device to the terminal device.

In some embodiments, the terminal device monitors the PDCCH candidate based on the control-resource set, the search space set, the second subcarrier spacing, and the new C-RNTI.

In some optional embodiments, the terminal device receives uplink grant information over the PDCCH of the target cell, and the terminal device transmits the PUSCH to the target cell over resources scheduled by the uplink grant information.

In some embodiments, the terminal device determines the first subcarrier spacing based on the subcarrier spacing configuration.

In some embodiments, the PUSCH transmitted by the terminal device to the target cell carries the first RNTI information. As another example, the first RNTI is included in a transport block carried by the PUSCH transmitted by the terminal device. As another example, the terminal device scrambles the PUSCH based on the first RNTI.

In some embodiments, a waveform of the PUSCH is determined based on the uplink transmission waveform information; and in some embodiments, the waveform of the PUSCH is predefined.

In some optional embodiments, the source network device is a network device of a source cell, and both the source network device and the terminal device retain context information, the context information being configured for the terminal device to return to the source cell in response to a handover failure.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, wherein the first handover message includes the PDCCH configuration, such that the problem of resource configuration in the RACH-less handover process is solved.

FIG. 5 is a flowchart of a method for configuring resources in a handover process according to some embodiments of the present disclosure. The method includes the following processes.

In process 520, a terminal device receives a first handover message from a source network device, wherein the first handover message is configured by a target network device, the target network device being a network device of a target cell, and the first handover message includes PDCCH configuration and configured grant configuration.

In some optional embodiments, the first handover message includes: a PDCCH configuration; a configured grant configuration; a control-resource set configuration; and a search space set configuration.

In some optional embodiments, the first handover message includes: a PDCCH configuration; a configured grant configuration; a subcarrier spacing configuration; a control-resource set configuration; a search space set configuration; and a first RNTI.

With respect to the PDCCH configuration, in some embodiments, the PDCCH configuration is configured to determine control-resource set configuration and/or search space set configuration associated with a PDCCH candidate of a target cell; and in some embodiments, the PDCCH configuration indicates a control-resource set ID and/or a search space set ID associated with the PDCCH candidate in the case that the terminal device monitors the PDCCH candidate of the target cell.

With respect to the configured grant configuration, in some embodiments, the configured grant configuration is configured to determine at least one of: a configured grant configuration ID, frequency domain frequency hopping indication, DMRS parameter configuration, a frequency domain resource allocation type, uplink transmission waveform information, the number of pre-configured uplink HARQ processes, periods of pre-granted resources, the number of repetitions of transmissions over the pre-granted resources, or a corresponding RV of repeated transmissions over the pre-granted resources.

In some embodiments, for the detailed description of the configured grant configuration, reference is made to the “with respect to the configured grant configuration” in process 220.

With respect to the subcarrier spacing configuration, in some embodiments, the subcarrier spacing configuration is configured to determine a first subcarrier spacing, wherein the first subcarrier spacing is configured for the terminal device to transmit the PUSCH and/or the PUCCH to the target cell. For example, the subcarrier spacing configuration indicates the first subcarrier spacing. In some embodiments, the subcarrier spacing configuration is configured to determine a second subcarrier spacing, wherein the second subcarrier spacing is configured for a terminal device to receive the PDCCH and/or the PDSCH from the target cell. For example, the subcarrier spacing configuration indicates the second subcarrier spacing.

With respect to the control-resource set configuration, in some embodiments, the control-resource set configuration indicates control-resource set configuration information associated with the control-resource set ID and/or the search space set ID. In some embodiments, the control-resource set configuration information is configured to determine at least one of: RBs occupied by a control-resource set in a frequency domain, the number of symbols occupied by the control-resource set in a time domain, or quasi co-location information associated with the control-resource set.

In some embodiments, for the detailed description of the control-resource set configuration, reference is made to the “with respect to the control-resource set configuration” in process 220.

With respect to the search space set configuration, in some embodiments, the search space set configuration indicates search space set configuration information associated with the search space set ID. In some embodiments, the search space set configuration information is configured to determine at least one of: time units occupied by a search space set in a time domain, symbols occupied by the search space set in occupied time units, a search space set type, a DCI format of a PDCCH candidate, an aggregation level associated with the PDCCH candidate, or blind monitoring times corresponding to the aggregation level of the PDCCH candidate.

In some embodiments, for the detailed description of the search space set configuration, reference is made to the “with respect to the search space set configuration” in process 220.

With respect to the first RNTI, in some embodiments, the first RNTI includes a C-RNTI allocated by the target network device to the terminal device; and in some embodiments, the first RNTI includes a CS-RNTI allocated by the target network device to the terminal device.

In process 540, the terminal device monitors the PDCCH of the target cell based on the PDCCH configuration.

In some optional embodiments, the terminal device monitors a PDCCH candidate based on the first RNTI on a search space set determined based on the PDCCH configuration.

In some embodiments, the terminal device determines a control-resource set ID and/or a search space set ID associated with the PDCCH candidate based on the PDCCH configuration.

In some embodiments, the terminal device determines the control-resource set based on the control-resource set configuration and at least one of the control-resource set ID or the search space set ID associated with the PDCCH candidate.

In some embodiments, the terminal device determines the search space set based on the search space set configuration and the search space set ID associated with the PDCCH candidate.

In some embodiments, the terminal device determines the second subcarrier spacing based on the subcarrier spacing configuration.

In some embodiments, the terminal device determines the first RNTI as the C-RNTI (also referred to as a new C-RNTI) allocated by the target network device to the terminal device.

In some embodiments, the terminal device monitors the PDCCH candidate based on the control-resource set, the search space set, the second subcarrier spacing, and the new C-RNTI.

In process 560, the terminal device receives activation grant of the configured grant configuration over the PDCCH of the target cell.

In some embodiments, the activation grant is configured to determine at least one of: time units occupied by the pre-granted resources in a time domain, starting symbols and the number of symbols occupied by the pre-granted resources in occupied time units, RBs occupied by the pre-granted resources in a frequency domain, an antenna port, a DMRS sequence initialization parameter, precoding and layer number indication, MCS and TBS indication, SRS resource indication, frequency domain frequency hopping offset indication, or path loss reference indication.

In some embodiments, the case that the activation grant is configured to determine the time units occupied by the pre-granted resources in the time domain includes that: the activation grant is configured to determine timeslots occupied by the pre-granted resources in the time domain based on time domain offset.

In some embodiments, the case that the activation grant is configured to determine the starting symbols and the number of symbols occupied by the pre-granted resources in the occupied time units includes that: the activation grant is configured to determine the starting symbols and the number of symbols occupied by the pre-granted resources in occupied timeslots based on time domain resource allocation information.

In some embodiments, the case that the activation grant is configured to determine the RBs occupied by the pre-granted resources in the frequency domain includes that: the activation grant is configured to determine the RBs occupied by the pre-granted resources in the frequency domain based on a frequency domain resource allocation parameter and a frequency domain resource allocation type.

In process 580, the terminal device accesses the target cell based on resources determined by the activation grant.

In some optional embodiments, the terminal device determines the pre-granted resources of the target cell based on the activation grant and the configured grant configuration; and upon synchronization with the target cell, the terminal device transmits the PUSCH to the target cell over a first available resource of the pre-granted resources.

In some embodiments, upon synchronization with the target cell, the terminal device determines the first subcarrier spacing based on the subcarrier spacing configuration.

In some embodiments, the PUSCH transmitted by the terminal device to the target cell carries the first RNTI information. As another example, the first RNTI is included in a transport block carried by the PUSCH transmitted by the terminal device. As another example, the terminal device scrambles the PUSCH based on the first RNTI.

In some embodiments, a waveform of the PUSCH is determined based on the uplink transmission waveform information; and in some embodiments, the waveform of the PUSCH is predefined.

In some optional embodiments, the source network device is a network device of a source cell, and both the source network device and the terminal device retain context information, the context information being configured for the terminal device to return to the source cell in response to a handover failure.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, wherein the first handover message includes the configured grant configuration and the PDCCH configuration, such that the problem of resource configuration in the RACH-less handover process is solved.

FIG. 6 shows a flowchart of a method for configuring resources in a handover process according to some embodiments of the present disclosure. The method includes the following processes.

In process 620, a target network device configures a first handover message.

In some optional embodiments, the first handover message carries configuration information associated with the NR system; and/or the source network device is a network device in the NR system; and/or the target network device is a network device in the NR system.

In some optional embodiments, the first handover message carries configuration information associated with the NTN system; and/or the source network device is a network device in the NTN system; and/or the target network device is a network device in the NTN system. In some embodiments, the first handover message includes timing adjustment indication information and/or an uplink scheduling timing offset value Koffset.

In some optional embodiments, the first handover message includes at least one of: a subcarrier spacing configuration; a PDCCH configuration; a control-resource set configuration; a search space set configuration; a configured grant configuration; a first RNTI; timing adjustment indication information; an uplink scheduling timing offset value Koffset; or uplink transmission waveform information.

With respect to the subcarrier spacing configuration, in some embodiments, the PUCCH to the target cell; and in some embodiments, the subcarrier spacing configuration is configured to determine a second subcarrier spacing, wherein the second subcarrier spacing is configured for the terminal device to receive the PDCCH and/or the PDSCH from the target cell.

With respect to the PDCCH configuration, in some embodiments, the PDCCH configuration is configured to determine control-resource set configuration and/or search space set configuration associated with a PDCCH candidate of the target cell. In some embodiments, the PDCCH configuration indicates a control-resource set ID and/or a search space set ID associated with the PDCCH candidate in the case that the terminal device monitors the PDCCH candidate of the target cell.

With respect to the control-resource set configuration, in some embodiments, the control-resource set configuration indicates control-resource set configuration information associated with the control-resource set ID and/or the search space set ID, wherein the control-resource set configuration information is configured to determine at least one of: RBs occupied by a control-resource set in a frequency domain, the number of symbols occupied by the control-resource set in a time domain, or quasi co-location information associated with the control-resource set.

In some embodiments, for the detailed description of the control-resource set configuration, reference is made to the “with respect to the control-resource set configuration” in process 220.

With respect to the search space set configuration, in some embodiments, the search space set configuration indicates search space set configuration information associated with the search space set ID, wherein the search space set configuration information is configured to determine at least one of: time units occupied by a search space set in a time domain, symbols occupied by the search space set in occupied time units, a search space set type, a DCI format of a PDCCH candidate, an aggregation level associated with the PDCCH candidate, or blind monitoring times corresponding to the aggregation level of the PDCCH candidate.

In some embodiments, for the detailed description of the search space set configuration, reference is made to the “with respect to the search space set configuration” in process 220.

With respect to the configured grant configuration, in some embodiments, the configured grant configuration is configured to determine at least one of: a configured grant configuration ID, frequency domain frequency hopping indication, DMRS parameter configuration, a frequency domain resource allocation type, uplink transmission waveform information, the number of pre-configured HARQ processes, periods of pre-granted resources, the number of repetitions of transmissions over the pre-granted resources, a corresponding RV of repeated transmissions over the pre-granted resources, time units occupied by the pre-granted resources in a time domain, starting symbols and the number of symbols occupied by the pre-granted resources in occupied time units, resource blocks (RBs) occupied by the pre-granted resources in a frequency domain, an antenna port, a DMRS sequence initialization parameter, precoding and layer number indication, MCS and TBS indication, SRS resource indication, frequency domain frequency hopping offset indication, or path loss reference indication.

In some embodiments, for the detailed description of the configured grant configuration, reference is made to the “with respect to the configured grant configuration” in process 220.

With respect to the first RNTI, in some embodiments, the first RNTI includes a C-RNTI allocated by the target network device to the terminal device; and in some embodiments, the first RNTI includes a CS-RNTI allocated by the target network device to the terminal device.

With respect to the timing adjustment indication information, in some embodiments, the timing adjustment indication information is configured to determine a TA value of the target cell. For example, the timing adjustment indication information is configured to determine a TA value used by the terminal device when performing PUSCH transmission based on PUSCH resources in the target cell.

In some embodiments, for the detailed description of the timing adjustment indication information, reference is made to the “with respect to the timing adjustment indication information” in process 220.

For the uplink scheduling timing offset value Koffset, in some embodiments, the uplink scheduling timing offset value Koffset is configured to determine at least one of the following scheduling timings: timing of PUSCH transmission from the terminal device to the first network device, or timing of PUCCH transmission from the terminal device to the first network device. In some embodiments, in this case, the uplink scheduling timing offset value Koffset is applied in the NTN network.

For the uplink transmission waveform information, in some embodiments, the uplink transmission waveform information is configured to determine whether a DFT precoder is used (or whether a waveform used is an OFDM waveform or a DFT-S-OFDM waveform) in the case that the terminal device performs uplink transmission to the target network device.

In some embodiments, for the detailed description of the uplink transmission waveform information, reference is made to the “for the uplink transmission waveform information” in process 220.

In process 640, the target network device transmits the first handover message to the terminal device over a source network device, wherein the first handover message is configured for the terminal device to access a target cell, and the target network device is a network device of the target cell.

In some optional embodiments, the first handover message carries resource configuration associated with the NR and/or the NTN, and the terminal device accesses the target cell based on access resource corresponding to the resource configuration.

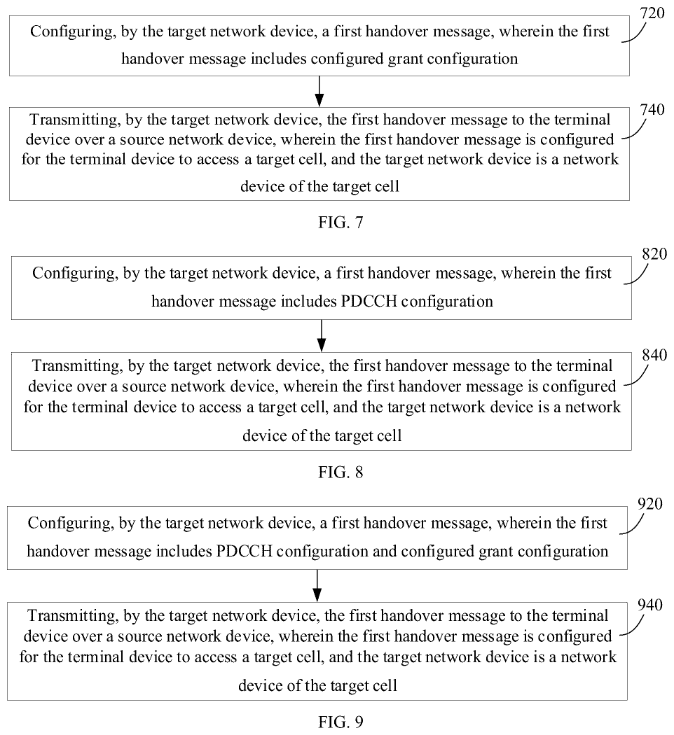

In some optional embodiments, the first handover message includes the configured grant configuration. The terminal device accesses the target cell based on the configured grant configuration; and reference is made in detail to the exemplary embodiments illustrated in FIG. 7 hereinafter.

In some optional embodiments, the first handover message includes the PDCCH configuration. The terminal device accesses the target cell based on the PDCCH configuration; and reference is made in detail to the exemplary embodiments illustrated in FIG. 8 hereinafter.

In some optional embodiments, the first handover message includes the PDCCH configuration and the configured grant configuration. The terminal device accesses the target cell based on the configured grant configuration and the PDCCH configuration; and reference is made in detail to the exemplary embodiments illustrated in FIG. 9 hereinafter.

In some optional embodiments, in the NTN scenario, for example, in the case that the first handover message carries configuration information associated with an NTN system; and/or the source network device is a network device in the NTN system; and/or the target network device is a network device in the NTN system, the case that the terminal device accesses the target cell based on the first handover message includes that: upon synchronization with the target cell, the terminal device accesses the target cell based on the first handover message.

In some embodiments, in the NTN scenario, the case that the terminal device synchronizes to the target cell includes that: the terminal device synchronizes to the target cell based on the first handover message, wherein the first handover message includes, the timing adjustment indication information being configured to determine at least one of: ephemeris information, a common TA value, a common drift value, a common drift variation rate, common transmission delay, a reference moment t0, or a timer length.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, such that the problem of resource configuration in the RACH-less handover process is solved.

FIG. 7 shows a flowchart of a method for configuring resources in a handover process according to some embodiments of the present disclosure. The method includes the following processes.

In process 720, the target network device configures a first handover message, wherein the first handover message includes configured grant configuration.

In some optional embodiments, the first handover message includes: a configured grant configuration; a subcarrier spacing configuration; and a first RNTI.

With respect to the configured grant configuration, in some embodiments, the configured grant configuration is configured to determine at least one of: a configured grant configuration ID; frequency domain frequency hopping indication; DMRS parameter configuration; a frequency domain resource allocation type; uplink transmission waveform information; the number of pre-configured uplink HARQ processes; periods of pre-granted resources, the number of repetitions of transmissions over the pre-granted resources; a corresponding RV of repeated transmissions over the pre-granted resources; time units occupied by the pre-granted resources in a time domain; starting symbols and the number of symbols occupied by the pre-granted resources in occupied time units; RBs occupied by the pre-granted resources in a frequency domain; an antenna port; a DMRS sequence initialization parameter; precoding and layer number indication; MCS and TBS indication; SRS resource indication; frequency domain frequency hopping offset indication; or path loss reference indication.

In some embodiments, for the detailed description of the configured grant configuration, reference is made to the “with respect to the configured grant configuration” in process 220.

With respect to the subcarrier spacing configuration, in some embodiments, the subcarrier spacing configuration is configured to determine a first subcarrier spacing, wherein the first subcarrier spacing is configured for the terminal device to transmit the PUSCH and/or the PUCCH to the target cell.

With respect to the first RNTI, in some embodiments, the first RNTI includes a C-RNTI allocated by the target network device to the terminal device.

In process 740, the target network device transmits the first handover message to the terminal device over a source network device, wherein the first handover message is configured for the terminal device to access a target cell, and the target network device is a network device of the target cell.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, wherein the first handover message includes the configured grant configuration, such that the problem of resource configuration in the RACH-less handover process is solved.

FIG. 8 shows a flowchart of a method for configuring resources in a handover process according to some embodiments of the present disclosure. The method includes the following processes.

In process 820, the target network device configures a first handover message, wherein the first handover message includes the PDCCH configuration.

In some optional embodiments, the first handover message includes: a PDCCH configuration; a subcarrier spacing configuration; a control-resource set configuration; a search space set configuration; and a first RNTI.

With respect to the PDCCH configuration, in some embodiments, the PDCCH configuration is configured to determine control-resource set configuration and/or search space set configuration associated with a PDCCH candidate of a target cell; and in some embodiments, the PDCCH configuration indicates a control-resource set ID and/or a search space set ID associated with the PDCCH candidate in the case that the terminal device monitors the PDCCH candidate of the target cell.

With respect to the subcarrier spacing configuration, in some embodiments, the subcarrier spacing configuration is configured to determine a first subcarrier spacing, wherein the first subcarrier spacing is configured for the terminal device to transmit the PUSCH and/or the PUCCH to the target cell. In some embodiments, the subcarrier spacing configuration is configured to determine a second subcarrier spacing, wherein the second subcarrier spacing is configured for a terminal device to receive the PDCCH and/or the PDSCH from the target cell.

With respect to the control-resource set configuration, in some embodiments, the control-resource set configuration indicates control-resource set configuration information associated with the control-resource set ID and/or the search space set ID. In some embodiments, the control-resource set configuration information is configured to determine at least one of: RBs occupied by a control-resource set in a frequency domain, the number of symbols occupied by the control-resource set in a time domain, or quasi co-location information associated with the control-resource set.

In some embodiments, for the detailed description of the control-resource set configuration, reference is made to the “with respect to the control-resource set configuration” in process 220.

With respect to the search space set configuration, in some embodiments, the search space set configuration indicates search space set configuration information associated with the search space set ID. In some embodiments, the search space set configuration information is configured to determine at least one of: time units occupied by a search space set in a time domain, symbols occupied by the search space set in occupied time units, a search space set type, a DCI format of a PDCCH candidate, an aggregation level associated with the PDCCH candidate, or blind monitoring times corresponding to the aggregation level of the PDCCH candidate.

In some embodiments, for the detailed description of the search space set configuration, reference is made to the “with respect to the search space set configuration” in process 220.

With respect to the first RNTI, in some embodiments, the first RNTI includes a C-RNTI allocated by the target network device to the terminal device.

In process 840, the target network device transmits the first handover message to the terminal device over a source network device, wherein the first handover message is configured for the terminal device to access a target cell, and the target network device is a network device of the target cell.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, wherein the first handover message includes the PDCCH configuration, such that the problem of resource configuration in the RACH-less handover process is solved.

FIG. 9 shows a flowchart of a method for configuring resources in a handover process according to some embodiments of the present disclosure. The method includes the following processes.

In process 920, the target network device configures a first handover message, wherein the first handover message includes the PDCCH configuration and the configured grant configuration.

In some optional embodiments, the first handover message includes: a PDCCH configuration; a configured grant configuration; a subcarrier spacing configuration; a control-resource set configuration; a search space set configuration; and a first RNTI.

With respect to the PDCCH configuration, in some embodiments, the PDCCH configuration is configured to determine control-resource set configuration and/or search space set configuration associated with a PDCCH candidate of a target cell; and in some embodiments, the PDCCH configuration indicates a control-resource set ID and/or a search space set ID associated with the PDCCH candidate in the case that the terminal device monitors the PDCCH candidate of the target cell.

With respect to the configured grant configuration, in some embodiments, the configured grant configuration is configured to determine at least one of: a configured grant configuration ID, frequency domain frequency hopping indication, DMRS parameter configuration, a frequency domain resource allocation type, uplink transmission waveform information, the number of pre-configured uplink HARQ processes, periods of pre-granted resources, the number of repetitions of transmissions over the pre-granted resources, or a corresponding RV of repeated transmissions over the pre-granted resources.

In some embodiments, for the detailed description of the configured grant configuration, reference is made to the “with respect to the configured grant configuration” in process 220.

With respect to the subcarrier spacing configuration, in some embodiments, the subcarrier spacing configuration is configured to determine a first subcarrier spacing, wherein the first subcarrier spacing is configured for the terminal device to transmit the PUSCH and/or the PUCCH to the target cell. In some embodiments, the subcarrier spacing configuration is configured to determine a second subcarrier spacing, wherein the second subcarrier spacing is configured for the terminal device to receive the PDCCH and/or the PDSCH from the target cell.

With respect to the control-resource set configuration, in some embodiments, the control-resource set configuration indicates control-resource set configuration information associated with the control-resource set ID and/or the search space set ID. In some embodiments, the control-resource set configuration information is configured to determine at least one of: RBs occupied by a control-resource set in a frequency domain, the number of symbols occupied by the control-resource set in a time domain, or quasi co-location information associated with the control-resource set.

In some embodiments, for the detailed description of the control-resource set configuration, reference is made to the “with respect to the control-resource set configuration” in process 220.

With respect to the search space set configuration, in some embodiments, the search space set configuration indicates search space set configuration information associated with the search space set ID. In some embodiments, the search space set configuration information is configured to determine at least one of: time units occupied by a search space set in a time domain, symbols occupied by the search space set in occupied time units, a search space set type, a DCI format of a PDCCH candidate, an aggregation level associated with the PDCCH candidate, or blind monitoring times corresponding to the aggregation level of the PDCCH candidate.

In some embodiments, for the detailed description of the search space set configuration, reference is made to the “with respect to the search space set configuration” in process 220.

With respect to the first RNTI, in some embodiments, the first RNTI includes a C-RNTI allocated by the target network device to the terminal device; and in some embodiments, the first RNTI includes a CS-RNTI allocated by the target network device to the terminal device.

In process 940, the target network device transmits the first handover message to the terminal device over a source network device, wherein the first handover message is configured for the terminal device to access a target cell, and the target network device is a network device of the target cell.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, wherein the first handover message includes the configured grant configuration and the PDCCH configuration, such that the problem of resource configuration in the RACH-less handover process is solved.

FIG. 10 shows a flowchart of a method for configuring resources in a handover process according to some embodiments of the present disclosure. The method includes the following processes.

In process 1020, a source network device receives a first handover message configured by a target network device.

In some optional embodiments, the first handover message carries configuration information associated with the NR system; and/or the source network device is a network device in the NR system; and/or the target network device is a network device in the NR system.

In some optional embodiments, the first handover message carries configuration information associated with the NTN system; and/or the source network device is a network device in the NTN system; and/or the target network device is a network device in the NTN system. In some embodiments, the first handover message includes timing adjustment indication information and/or an uplink scheduling timing offset value Koffset.

In process 1040, the source network device transmits the first handover message to a terminal device, wherein the first handover message is configured for the terminal device to access a target cell, and the target network device is a network device of the target cell.

In some optional embodiments, the terminal device is configured with a RACH-less handover process, or the PRACH resource configuration is not included in the first handover message.

In some optional embodiments, the terminal device is configured with a RACH-less-based handover process, or a RACH-less handover process, or an uplink data channel-based handover process.

In summary, the first handover message is configured by the target network device and forwarded to the terminal device over the source network device, and the terminal device accesses the target cell of the target network device based on the first handover message, such that the problem of resource configuration in the RACH-less handover process is solved.

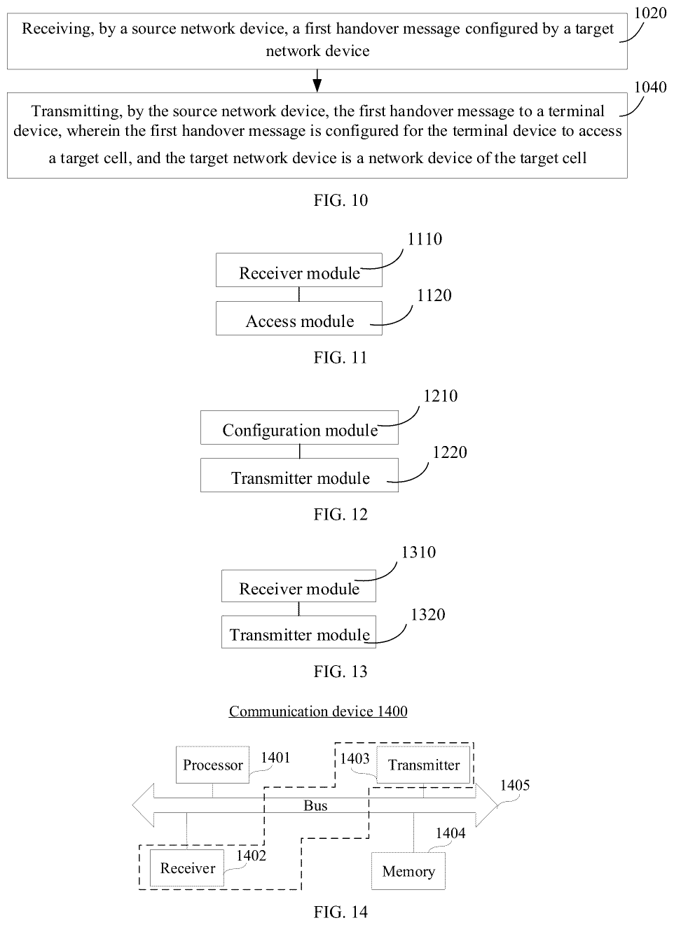

FIG. 11 shows a structural block diagram of an apparatus for configuring resources in a handover process according to some embodiments of the present disclosure. The apparatus includes: a receiver module 1110, configured to receive a first handover message from a source network device, wherein the first handover message is configured by a target network device, the target network device being a network device of a target cell; and an access module 1120, configured to access the target cell based on the first handover message.

In some optional embodiments, the first handover message includes at least one of: a subcarrier spacing configuration; a PDCCH configuration; a control-resource set configuration; a search space set configuration; a configured grant configuration; a first RNTI; timing adjustment indication information; an uplink scheduling timing offset value Koffset; or uplink transmission waveform information.

In some optional embodiments, the first handover message includes the configured grant configuration.

In some optional embodiments, the access module 1120 is further configured to determine pre-granted resources of the target cell based on the configured grant configuration.

In some optional embodiments, the access module 1120 is further configured to access the target cell based on at least one resource of the pre-granted resources.

In some optional embodiments, the access module 1120 is further configured to transmit the PUSCH to the target cell over a first available resource of the pre-granted resources upon synchronization with the target cell.

In some optional embodiments, the first handover message further includes the subcarrier spacing configuration and the first RNTI.

In some optional embodiments, the configured grant configuration is configured to determine at least one of: a configured grant configuration ID; frequency domain frequency hopping indication; a DMRS parameter configuration; a frequency domain resource allocation type; uplink transmission waveform information; the number of pre-configured uplink HARQ processes; periods of pre-granted resources; the number of repetitions of transmissions over the pre-granted resources; a corresponding RV of repeated transmissions over the pre-granted resources; time units occupied by the pre-granted resources in a time domain; starting symbols and the number of symbols occupied by the pre-granted resources in occupied time units; RBs occupied by the pre-granted resources in a frequency domain; an antenna port; a DMRS sequence initialization parameter; precoding and number of layers indication; MCS and TBS indication; SRS resource indication; frequency domain frequency hopping offset indication; or path loss reference indication.

In some optional embodiments, the first handover message includes the PDCCH configuration.

In some optional embodiments, the access module 1120 is further configured to access the target cell by monitoring the PDCCH of the target cell based on the PDCCH configuration.

In some optional embodiments, the access module 1120 is further configured to monitor the PDCCH of the target cell based on the PDCCH configuration.

In some optional embodiments, the access module 1120 is further configured to receive uplink grant information over the PDCCH of the target cell.

In some optional embodiments, the access module 1120 is further configured to transmit the PUSCH to the target cell over resources scheduled by the uplink grant information.

In some optional embodiments, the first handover message further includes the subcarrier spacing configuration, the control-resource set configuration, the search space set configuration, and the first RNTI.

In some optional embodiments, the PDCCH configuration is configured to determine control-resource set configuration and/or search space set configuration associated with a PDCCH candidate of the target cell.

In some optional embodiments, the first handover message includes the PDCCH configuration and the configured grant configuration.

In some optional embodiments, the access module 1120 is further configured to monitor the PDCCH of the target cell based on the PDCCH configuration and receive activation grant of the configured grant configuration over the PDCCH of the target cell.

In some optional embodiments, the access module 1120 is further configured to access the target cell based on resources determined by the activation grant.

In some optional embodiments, the access module 1120 is further configured to determine pre-granted resources of the target cell based on the activation grant and the configured grant configuration.

In some optional embodiments, the access module 1120 is further configured to transmit the PUSCH to the target cell over a first available resource of the pre-granted resources upon synchronization with the target cell.

In some optional embodiments, the first handover message further includes the subcarrier spacing configuration, the control-resource set configuration, the search space set configuration, and the first RNTI.

In some optional embodiments, the PDCCH configuration is configured to determine control-resource set configuration and/or search space set configuration associated with a PDCCH candidate of the target cell.

In some optional embodiments, the configured grant configuration is configured to determine at least one of: a configured grant configuration ID; frequency domain frequency hopping indication; a DMRS parameter configuration; a frequency domain resource allocation type; uplink transmission waveform information; the number of pre-configured uplink HARQ processes; periods of the pre-granted resources; the number of repetitions of transmissions over the pre-granted resources; or a corresponding RV of repeated transmissions over pre-granted resources.

In some optional embodiments, the activation grant is configured to determine at least one of: time units occupied by the pre-granted resources in a time domain; starting symbols and the number of symbols occupied by the pre-granted resources in the occupied time units; RBs occupied by the pre-granted resources in a frequency domain; an antenna port; a DMRS sequence initialization parameter; precoding and layer number indication; MCS and TBS indication; SRS resource indication; frequency domain frequency hopping offset indication; or path loss reference indication.

In some optional embodiments, the access module 1120 is further configured to monitor the PDCCH candidate based on the first RNTI on a search space set determined based on the PDCCH configuration.

In some optional embodiments, the first RNTI includes a CS-RNTI allocated by the target network device to the terminal device.

In some optional embodiments, the first RNTI includes a C-RNTI allocated by the target network device to the terminal device.

In some optional embodiments, the PDCCH configuration indicates a control-resource set ID and/or a search space set ID associated with the PDCCH candidate in the case that the terminal device monitors the PDCCH candidate of the target cell.

In some optional embodiments, the control-resource set configuration indicates control-resource set configuration information associated with the control-resource set ID and/or the search space set ID; wherein

the control-resource set configuration information is configured to determine at least one of: RBs occupied by a control-resource set in a frequency domain; the number of symbols occupied by the control-resource set in a time domain; or quasi co-location information associated with the control-resource set.

In some optional embodiments, the search space set configuration indicates search space set configuration information associated with the search space set ID; wherein the search space set configuration information is configured to determine at least one of: time units occupied by a search space set in a time domain; symbols occupied by the search space set in occupied time units; a search space set type; a DCI format of the PDCCH candidate; an aggregation level associated with the PDCCH candidate; or blind monitoring times corresponding to the aggregation level of the PDCCH candidate.

In some optional embodiments, the subcarrier spacing configuration is configured to determine a first subcarrier spacing, wherein the first subcarrier spacing is configured for the terminal device to transmit the PUSCH and/or the PUCCH to the target cell.

In some optional embodiments, the subcarrier spacing configuration is configured to determine a second subcarrier spacing, wherein the second subcarrier spacing is configured for the terminal device to receive the PDCCH and/or the PDSCH from the target cell.

In some optional embodiments, the uplink transmission waveform information is configured to determine that a waveform used in the case that the terminal device performs uplink transmission to the target cell is a DFT-S-OFDM waveform or an OFDM waveform.

In some optional embodiments, a waveform of the PUSCH is determined based on the uplink transmission waveform information; or the waveform of the PUSCH is predefined.

In some optional embodiments, the source network device is a network device of a source cell, and both the source network device and the terminal device retain context information, the context information being configured for the terminal device to return to the source cell in response to a handover failure.

In some optional embodiments, the first handover message carries configuration information associated with the NR system; and/or the source network device is a network device in the NR system; and/or the target network device is a network device in the NR system.

In some optional embodiments, the first handover message carries configuration information associated with the NTN system; and/or the source network device is the network device in the NTN system; and/or the target network device is the network device in the NTN system.

In some optional embodiments, the first handover message includes the timing adjustment indication information and/or the uplink scheduling timing offset value Koffset.

In summary, the first handover message is configured by the target network device and forwarded to the above-mentioned apparatus over the source network device, and the above-mentioned apparatus accesses the target cell of the target network device based on the first handover message, such that the problem of resource configuration in the RACH-less handover process is solved.

FIG. 12 shows a structural block diagram of an apparatus for configuring resources in a handover process according to some embodiments of the present disclosure. The apparatus includes: a configuration module 1210, configured to configure a first handover message; and a transmitter module 1220, configured to transmit the first handover message to a terminal device over a source network device; wherein the first handover message is configured for the terminal device to access a target cell, a target network device being configured in the target cell.

In some optional embodiments, the first handover message includes at least one of: a subcarrier spacing configuration; a PDCCH configuration; a control-resource set configuration; a search space set configuration; a configured grant configuration; a first RNTI; timing adjustment indication information; an uplink scheduling timing offset value Koffset; or uplink transmission waveform information.

In some optional embodiments, the first handover message includes the configured grant configuration.

In some optional embodiments, the first handover message further includes the subcarrier spacing configuration and the first RNTI.

In some optional embodiments, the configured grant configuration is configured to determine at least one of: a configured grant configuration ID; frequency domain frequency hopping indication; a DMRS parameter configuration; a frequency domain resource allocation type; uplink transmission waveform information; the number of pre-configured uplink HARQ processes; periods of pre-granted resources; the number of repetitions of transmissions over the pre-granted resources; a corresponding RV of repeated transmissions over the pre-granted resources; time units occupied by the pre-granted resources in a time domain; starting symbols and the number of symbols occupied by the pre-granted resources in occupied time units; RBs occupied by the pre-granted resources in a frequency domain; an antenna port; a DMRS sequence initialization parameter; precoding and layer number indication; MCS and TBS indication; SRS resource indication; frequency domain frequency hopping offset indication; or path loss reference indication.

In some optional embodiments, the first handover message includes a PDCCH configuration.

In some optional embodiments, the first handover message further includes a subcarrier spacing configuration, a control-resource set configuration, a search space set configuration, and the first RNTI.

In some optional embodiments, the PDCCH configuration is configured to determine a control-resource set configuration and/or a search space set configuration associated with a PDCCH candidate of the target cell.

In some optional embodiments, the first handover message includes a PDCCH configuration and a configured grant configuration.

In some optional embodiments, the first handover message further includes a subcarrier spacing configuration, a control-resource set configuration, a search space set configuration, and the first RNTI.

In some optional embodiments, the PDCCH configuration is configured to determine a control-resource set configuration and/or a search space set configuration associated with a PDCCH candidate of the target cell.

In some optional embodiments, the configured grant configuration is configured to determine at least one of: a configured grant configuration ID; frequency domain frequency hopping indication; a DMRS parameter configuration; a frequency domain resource allocation type; uplink transmission waveform information; the number of pre-configured uplink HARQ processes; periods of the pre-granted resources; the number of repetitions of transmissions over the pre-granted resources; or a corresponding RV of repeated transmissions over the pre-granted resources.

In some optional embodiments, the first RNTI includes a CS-RNTI allocated by the target network device to the terminal device.

In some optional embodiments, the first RNTI includes a C-RNTI allocated by the target network device to the terminal device.

In some optional embodiments, the PDCCH configuration indicates a control-resource set ID and/or a search space set ID associated with a PDCCH candidate in the case that the terminal device monitors the PDCCH candidate of the target cell.

In some optional embodiments, the control-resource set configuration indicates control-resource set configuration information associated with the control-resource set ID and/or the search space set ID; wherein the control-resource set configuration information is configured to determine at least one of: RBs occupied by a control-resource set in a frequency domain; the number of symbols occupied by the control-resource set in a time domain; or quasi co-location information associated with the control-resource set.

In some optional embodiments, the search space set configuration indicates search space set configuration information associated with the search space set ID; wherein the search space set configuration information is configured to determine at least one of: time units occupied by a search space set in a time domain; symbols occupied by the search space set in occupied time units; a search space set type; a DCI format of the PDCCH candidate; an aggregation level associated with the PDCCH candidate; or blind monitoring times corresponding to the aggregation level of the PDCCH candidate.

In some optional embodiments, the subcarrier spacing configuration is configured to determine a first subcarrier spacing, wherein the first subcarrier spacing is configured for the terminal device to transmit the PUSCH and/or the PUCCH to the target cell.

In some optional embodiments, the subcarrier spacing configuration is configured to determine a second subcarrier spacing, wherein the second subcarrier spacing is configured for the terminal device to receive the PDCCH and/or the PDSCH from the target cell.

In some optional embodiments, the uplink transmission waveform information is configured to determine a waveform used in the case that the terminal device performs uplink transmission to the target cell.

In some optional embodiments, the uplink transmission waveform information is configured to determine that a waveform used in the case that the terminal device performs uplink transmission to the target cell is a DFT-S-OFDM waveform or an OFDM waveform.

In some optional embodiments, the first handover message carries configuration information associated with the NR system; and/or the source network device is a network device in the NR system; and/or the target network device is a network device in the NR system.

In some optional embodiments, the first handover message carries configuration information associated with the NTN system; and/or the source network device is a network device in the NTN system; and/or the target network device is a network device in the NTN system.

In some optional embodiments, the first handover message includes timing adjustment indication information and/or an uplink scheduling timing offset value Koffset.

In summary, the first handover message is configured by the above-mentioned apparatus and forwarded to the terminal device over the source network device, and the terminal device accesses the target cell of the target network device based on the first handover message, such that the problem of resource configuration in the RACH-less handover process is solved.

FIG. 13 shows a structural block diagram of an apparatus for configuring resources in a handover process according to some embodiments of the present disclosure. The apparatus includes: a receiver module 1310, configured to receive a first handover message configured by a target network device; and a transmitter module 1320, configured to transmit the first handover message to a terminal device; wherein the first handover message is configured for the terminal device to access a target cell, and the target network device is a network device of the target cell.

In some optional embodiments, the source network device is a network device of a source cell, and both the source network device and the terminal device retain context information, the context information being configured for the terminal device to return to the source cell in response to a handover failure.

In summary, the first handover message is configured by the target network device and forwarded to the terminal device over the above-mentioned apparatus, and the terminal device accesses the target cell of the target network device based on the first handover message, such that the problem of resource configuration in the RACH-less handover process is solved.

FIG. 14 shows a schematic structural diagram of a communication device (a UE or a network device) according to some embodiments of the present disclosure, wherein the communication device includes: a processor 1401, a receiver 1402, a transmitter 1403, a memory 1404, and a bus 1405.

The processor 1401 includes one or more processing cores, and the processor 1401 performs various functional applications and information processing by running a software program and a module.

The receiver 1402 and the transmitter 1403 are implemented as a communication assembly, wherein the communication assembly may be a communication chip.

The memory 1404 is connected to the processor 1401 via the bus 1405.

The memory 1404 is configured to store at least one instruction, and the processor 1401, when loading and running the at least one instruction, is caused to perform the processes in the above method embodiments.

In addition, the memory 1404 is implemented by any type or combination of volatile or non-volatile storage devices including, but not limited to: magnetic or optical disks, electrically-erasable programmable read-only memories (EEPROMs), erasable programmable read-only memories (EPROMs), static random-access memories (SRAMs), read-only memories (ROMs), magnetic memories, flash memories, and programmable read-only memories (PROMs).

In an exemplary embodiment, a non-transitory computer-readable storage medium including an instruction, such as a memory including an instruction, is further provided. The instruction, when loaded and run by a processor of a communication device, causes the communication device to perform the method for configuring resources in a handover process. For example, the non-transitory computer-readable storage medium is a ROM, a random-access memory (RAM), a compact disc read-only memory (CD-ROM), a magnetic tape, a floppy disk, an optical data storage device, or the like.

A non-transitory computer-readable storage medium including an instruction is provided. The instruction, when loaded and run by a processor of a communication device, causes the communication device to perform the method for configuring resources in a handover process.

A network device is provided in an exemplary embodiment of the present disclosure. The network device includes: a processor and a transceiver connected to the processor; wherein the processor, when loading and running an executable instruction, is caused to perform the method for configuring resources in a handover process according to the above method embodiments.

A chip is provided in an exemplary embodiment of the present disclosure. The chip includes a programmable logic circuit and/or a program instruction. The chip, when running, is caused to perform the method for configuring resources in a handover process according to the above method embodiments.

A computer-readable storage medium is provided in an exemplary embodiment of the present disclosure. The computer-readable storage medium stores at least one instruction, at least one program, a code set, or an instruction set therein. The at least one instruction, the at least one program, the code set, or the instruction set, when loaded and run by a processor, causes the processor to perform the method for configuring resources in a handover process according to the above method embodiments.

It is understandable that the term “a plurality of” means two or more. The term “and/or” describes an association relationship of associated objects, and indicates that three relationships may be present. For example, A and/or B may mean that: A is present alone, A and B are present simultaneously, and B is present alone. The symbol “/” generally indicates an “or” relationship between the associated objects.

Other embodiments of the present disclosure are apparent to those skilled in the art from consideration of the specification and practice of the present invention disclosed herein. The present disclosure is intended to cover any variations, uses, or adaptations of the present disclosure, wherein the variations, the uses, or the adaptations follow general principles of the present disclosure and include known common knowledge or customary technical means undisclosed in the art of the present disclosure. The specification and embodiments are only considered as exemplary, and a true scope and spirit of the present disclosure are indicated in the following claims.

It is understandable that the present disclosure is not limited to the precise arrangements that have been described above and shown in the accompanying drawings, and that various modifications and changes may be made without departing from the scope thereof. The scope of the present disclosure is limited only by the appended claims.

1. A method for configuring resources in a handover process, comprising:
receiving, by a terminal device, a first handover message from a source network device, wherein the first handover message is configured by a target network device, the target network device being a network device of a target cell; and
accessing, by the terminal device, the target cell based on the first handover message;
wherein the first handover message comprises at least one of:
a subcarrier spacing configuration;
a physical downlink control channel (PDCCH) configuration;
a control-resource set configuration, wherein the control-resource set configuration indicates control-resource set configuration information associated with a control-resource set ID and/or a search space set ID, the control-resource set configuration information being configured to determine quasi co-location information associated with the control-resource set;
a search space set configuration;
a configured grant configuration;
a first radio network temporary identifier (RNTI), wherein the first RNTI comprises a cell-radio network temporary identifier (C-RNTI) allocated by the target network device to the terminal device;
timing adjustment indication information, wherein the timing adjustment indication information indicates N_{TA}=0;
an uplink scheduling timing offset value Koffset; or
uplink transmission waveform information, wherein the uplink transmission waveform information is configured to determine that a waveform used in a case that the terminal device performs uplink transmission to the target cell is a discrete Fourier transform-spread-orthogonal frequency division multiplexing (DFT-S-OFDM) waveform or an orthogonal frequency division multiplexing (OFDM) waveform.

2. The method according to claim 1, wherein:
the first handover message comprises the configured grant configuration; and
accessing, by the terminal device, the target cell based on the first handover message comprises:
determining, by the terminal device, pre-granted resources of the target cell based on the configured grant configuration; and
transmitting by the terminal device, upon synchronization with the target cell, a physical uplink shared channel (PUSCH) to the target cell over a first available resource of the pre-granted resources.

3. The method according to claim 1, wherein the configured grant configuration is configured to determine at least one of:
a configured grant configuration ID;
frequency domain frequency hopping indication;
a demodulation reference signal (DMRS) parameter configuration;
a frequency domain resource allocation type;
the uplink transmission waveform information;
a number of pre-configured uplink hybrid automatic repeat request (HARQ) processes;
periods of the pre-granted resources;
a number of repetitions of transmissions over the pre-granted resources;
a corresponding redundancy version (RV) of repeated transmissions over the pre-granted resources;
time units occupied by the pre-granted resources in a time domain;
starting symbols and a number of symbols occupied by the pre-granted resources in occupied time units;
resource blocks (RBs) occupied by the pre-granted resources in a frequency domain;
an antenna port;
a DMRS sequence initialization parameter;
precoding and number of layers indication;
modulation and coding scheme (MCS) and transport block size (TBS) indication;
sounding reference signal (SRS) resource indication;
frequency domain frequency hopping offset indication; or
path loss reference indication.

4. The method according to claim 1, wherein:
the first handover message comprises the PDCCH configuration, wherein the PDCCH configuration is configured to determine control-resource set configuration associated with a PDCCH candidate of the target cell, and the control-resource set configuration indicates control-resource set configuration information associated with a control-resource set ID, the control-resource set configuration information being configured to determine quasi co-location information associated with the control-resource set; and
accessing, by the terminal device, the target cell based on the first handover message comprises:
accessing, by the terminal device, the target cell by monitoring a PDCCH of the target cell based on the PDCCH configuration.

5. The method according to claim 4, wherein accessing, by the terminal device, the target cell by monitoring the PDCCH of the target cell based on the PDCCH configuration comprises:
monitoring, by the terminal device, the PDCCH of the target cell based on the PDCCH configuration;
receiving, by the terminal device, uplink grant information over the PDCCH of the target cell; and
transmitting, by the terminal device, a PUSCH to the target cell over resources scheduled by the uplink grant information.

6. The method according to claim 4, wherein the first handover message includes the first RNTI, and monitoring, by the terminal device, the PDCCH of the target cell based on the PDCCH configuration comprises:
monitoring, by the terminal device, a PDCCH candidate based on the first RNTI on a search space set determined based on the PDCCH configuration.

7. A communication device, comprising:
a processor and a memory, wherein the memory is configured to store a computer program, which when executed by the processor, causes the processor to:
receive a first handover message from a source network device, wherein the first handover message is configured by a target network device, the target network device being a network device of a target cell; and
access the target cell based on the first handover message;
wherein the first handover message comprises at least one of:
a subcarrier spacing configuration;
a physical downlink control channel (PDCCH) configuration;
a control-resource set configuration, wherein the control-resource set configuration indicates control-resource set configuration information associated with a control-resource set ID and/or a search space set ID, the control-resource set configuration information being configured to determine quasi co-location information associated with the control-resource set;
a search space set configuration;
a configured grant configuration;
a first radio network temporary identifier (RNTI), wherein the first RNTI comprises a cell-radio network temporary identifier (C-RNTI) allocated by the target network device to a terminal device;
timing adjustment indication information, wherein the timing adjustment indication information indicates N_{TA}=0;
an uplink scheduling timing offset value Koffset; or
uplink transmission waveform information, wherein the uplink transmission waveform information is configured to determine that a waveform used in a case that the terminal device performs uplink transmission to the target cell is a discrete Fourier transform-spread-orthogonal frequency division multiplexing (DFT-S-OFDM) waveform or an orthogonal frequency division multiplexing (OFDM) waveform.

8. The communication device according to claim 7, wherein:
the first handover message comprises the configured grant configuration; and
the computer program, which when executed by the processor, further causes the processor to:
determine, by the terminal device, pre-granted resources of the target cell based on the configured grant configuration; and
transmit, by the terminal device, upon synchronization with the target cell, a physical uplink shared channel (PUSCH) to the target cell over a first available resource of the pre-granted resources.

9. The communication device according to claim 7, wherein:
the first handover message comprises the PDCCH configuration, wherein the PDCCH configuration is configured to determine control-resource set configuration associated with a PDCCH candidate of the target cell, and the control-resource set configuration indicates control-resource set configuration information associated with a control-resource set ID, the control-resource set configuration information being configured to determine quasi co-location information associated with the control-resource set; and
the computer program, which when executed by the processor, further causes the processor to:
access, by the terminal device, the target cell by monitoring a PDCCH of the target cell based on the PDCCH configuration.

10. The communication device according to claim 7, wherein the quasi co-location information comprises at least one of: transmission configuration indicator (TCI) information, quasi co-location reference signal information, or quasi co-location type configuration.

11. The communication device according to claim 7, wherein the search space set configuration indicates search space set configuration information associated with a search space set ID;
wherein the search space set configuration information is configured to determine at least one of:
time units occupied by a search space set in a time domain;
symbols occupied by the search space set in occupied time units;
a search space set type;
a DCI format of a PDCCH candidate;
an aggregation level associated with the PDCCH candidate; or
blind monitoring times corresponding to the aggregation level of the PDCCH candidate.

12. The communication device according to claim 7, wherein the subcarrier spacing configuration is configured to determine at least one of a first subcarrier spacing or a second subcarrier spacing, wherein the first subcarrier spacing is configured for the terminal device to transmit at least one of a PUSCH or a physical uplink control channel (PUCCH) to the target cell, and the second subcarrier spacing is configured for the terminal device to receive at least one of a PDCCH or a physical downlink shared channel (PDSCH) from the target cell.

13. The communication device according to claim 7, wherein:
the first handover message carries configuration information associated with a non-terrestrial network (NTN) system, the first handover message comprising an uplink scheduling timing offset value Koffset; and/or
the source network device is a network device in the NTN system; and/or
the target network device is a network device in the NTN system.

14. A communication device, comprising:
a processor and a memory, wherein the memory is configured to store a computer program, which when executed by the processor, causes the processor to:
configure a first handover message; and
transmit the first handover message to a terminal device over a source network device;
wherein the first handover message comprises at least one of:
a subcarrier spacing configuration;
a physical downlink control channel (PDCCH) configuration;
a control-resource set configuration, wherein the control-resource set configuration indicates control-resource set configuration information associated with a control-resource set ID and/or a search space set ID, the control-resource set configuration information being configured to determine quasi co-location information associated with the control-resource set;
a search space set configuration;
a configured grant configuration;
a first radio network temporary identifier (RNTI), wherein the first RNTI comprises a cell-radio network temporary identifier (C-RNTI) allocated by a target network device to the terminal device;
timing adjustment indication information, wherein the timing adjustment indication information indicates N_{TA}=0;
an uplink scheduling timing offset value Koffset; or
uplink transmission waveform information, wherein the uplink transmission waveform information is configured to determine that a waveform used in a case that the terminal device performs uplink transmission to a target cell is a discrete Fourier transform-spread-orthogonal frequency division multiplexing (DFT-S-OFDM) waveform or an orthogonal frequency division multiplexing (OFDM) waveform.

15. The communication device according to claim 14, wherein the first handover message comprises the configured grant configuration.

16. The communication device according to claim 14, wherein the configured grant configuration is configured to determine at least one of:
a configured grant configuration ID;
frequency domain frequency hopping indication;
a demodulation reference signal (DMRS) parameter configuration;
a frequency domain resource allocation type;
the uplink transmission waveform information;
a number of pre-configured uplink hybrid automatic repeat request (HARQ) processes;
periods of the pre-granted resources;
a number of repetitions of transmissions over the pre-granted resources;
a corresponding redundancy version (RV) of repeated transmissions over the pre-granted resources;
time units occupied by the pre-granted resources in a time domain;
starting symbols and a number of symbols occupied by the pre-granted resources in occupied time units;
resource blocks (RBs) occupied by the pre-granted resources in a frequency domain;
an antenna port;
a DMRS sequence initialization parameter;
precoding and number of layers indication;
modulation and coding scheme (MCS) and transport block size (TBS) indication;
sounding reference signal (SRS) resource indication;
frequency domain frequency hopping offset indication; or
path loss reference indication.

17. The communication device according to claim 14, wherein the first handover message comprises the PDCCH configuration, wherein the PDCCH configuration is configured to determine control-resource set configuration associated with a PDCCH candidate of the target cell, and the control-resource set configuration indicates control-resource set configuration information associated with a control-resource set ID, the control-resource set configuration information being configured to determine quasi co-location information associated with the control-resource set.

18. The communication device according to claim 14, wherein the quasi co-location information comprises at least one of: transmission configuration indicator (TCI) information, quasi co-location reference signal information, or quasi co-location type configuration.

19. The communication device according to claim 14, wherein the search space set configuration indicates search space set configuration information associated with a search space set ID;
wherein the search space set configuration information is configured to determine at least one of:
time units occupied by a search space set in a time domain;
symbols occupied by the search space set in the occupied time units;
a search space set type;
a DCI format of a PDCCH candidate;
an aggregation level associated with the PDCCH candidate; or
blind monitoring times corresponding to the aggregation level of the PDCCH candidate.

20. A chip, comprising:
a programmable logic circuit and/or a program instruction, wherein the chip is configured to perform the method of claim 1.
